(19) United States
(12) Patent Application Publication
(10) Pub. No.: US 2006/0112673 A1
(43) Pub. Date: Jun. 1, 2006

(54) Photoelectric propulsion drive

(76) Inventor: Joseph Vito Pellegrino, Sayville, NY (US)

Correspondence Address: Joseph V Pollegrino, 298 Adam's Way, Sayville, NY, 11782, US

(21) Appl. No.: 10/997,657

(22) Filed: Nov. 26, 2004

(51) Int. Cl. F03H 1/00

(52) U.S. Cl. 60/203.1

(57) ABSTRACT

This invention is a device(s) that will utilize the power of photons to transfer their energy to electrons in turn transferring their energy to another object of mass that the casing(s) of the drive will be connected to by bombarding a wall of a negative electric field. This energy will then be transferred to the object this device(s) is connected to causing it to move in the same direction of the flow of the electrons. In theory the device(s) should cause movement up to ⅓ the speed of light. This will aid NASA any others that need or want to travel the solar system(s) in a more reasonable time frame. The fundamental principal behind the propulsion is the same as the solar sail. When high energy particles hit something, some of their energy is transferred to that object, and when the electrons are hit by photons of high energy, the photons energy is transferred to the electron and then in turn when the electron's energy is then transferred to the wall it hits and whatever it's connected to. I do suggest, though, that this drive be used in outer space and be lifted first from the earth via some other propulsion like a rocket. I do not feel currently it can produce enough “net force” to break away from earth's gravity on it's own.

### CROSS-REFERENCE TO RELATED APPLICATIONS

Non-applicable

### STATEMENT REGARDING FEDERALLY SPONSORED RESEARCH OR DEVELOPMENT

Non-applicable

### REFERENCE TO A MICROFICHE APPENDIX

Non-applicable

### BACKGROUND OF THE INVENTION

Non-applicable

### BRIEF SUMMARY OF THE INVENTION

This device will use a gamma ray laser(s) aimed at free electrons expelling from electron guns (or/and any other device(s) or system(s) that emits free electrons) and propelled into a concave wall producing a negative electric field. The energy transfers from the electrons to the atoms will produce high speeds possibly close to the speed of light.

In order for us to better achieve exploration of our solar system, we must first get to higher speeds. Only then will we are able to do a more detailed surveying of the planets around us.

### BRIEF DESCRIPTION OF THE SEVERAL VIEWS OF THE DRAWING

FIG. 1. Is a side view of a conceptual drawing of a multi-laser output for the Photoelectric Propulsion Drive;

FIG. 2. Is a side view of a conceptual drawing of a multi-chamber output for the Photoelectric Propulsion Drive.

### DETAILED DESCRIPTION OF THE INVENTION

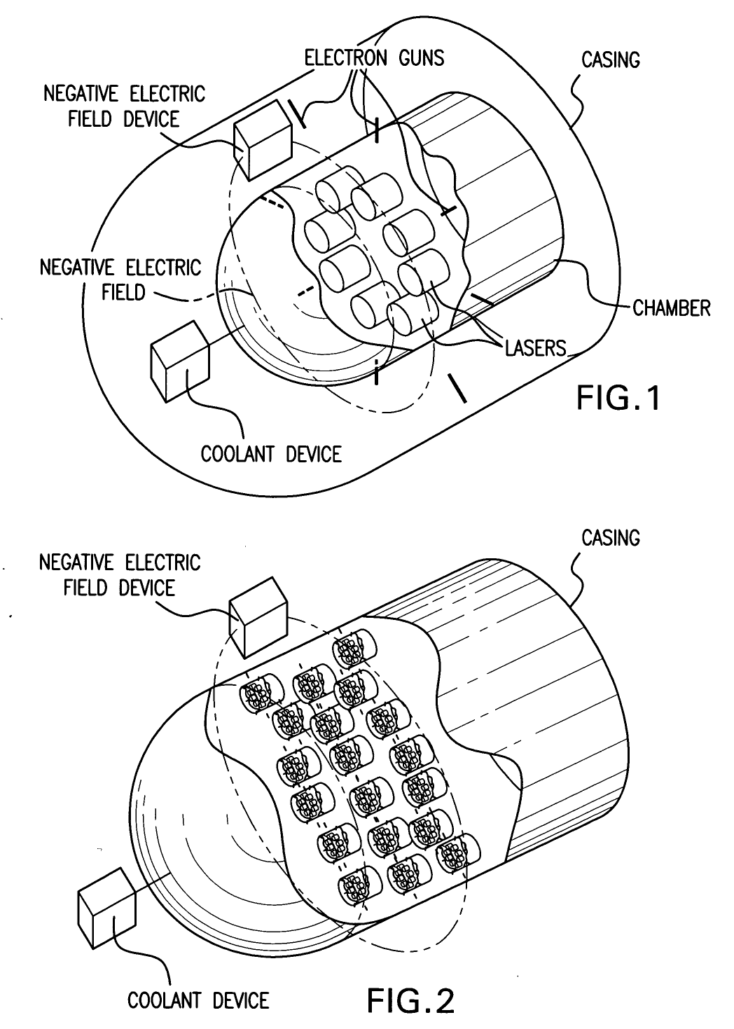

This invention is an engine using a gamma-ray laser aimed at electrons that will be coming from an electron gun(s) (or/and any other device(s) or system(s) that emits free electrons). The electrons being pushed using Compton's effect will transfer their energy to the electron, propelling the electron down a small distance inside a chamber into a concave shaped wall connected to a device(s) that will produce a negative electric field on the wall. Due to the photoelectric effect, electrons, when hitting the gamma rays will spin in a coil and the angle of their coil will be based on where the gamma ray hit on the electron. The gamma-ray laser(s) and electron gun(s) (or/and any other device(s) that emits free electrons), will have to be positioned to allow the electron's coiling to spin into the direction of the negative electric field to transfer the energy they received from the gamma-rays. The electrons will transfer their energy into the negative electric field and into whatever the drive is connected too thereof. Bare in mind, there can be many lasers as in FIG. 1 or a singular laser output where as there would only be one laser centered in middle of FIG. 1 and instead of having FIG. 2, have multiple drives of FIG. 1 connected to each other for multiple output

I claim:

1. A Photoelectric Propulsion Drive, comprising:
a) gamma-ray laser(s);
b) electron gun(s) (or/and any other device(s) or system(s) that emits free electrons);
c) a casing(s) made of (or be covered by) radiation blocking material that will have a chamber(s) with said device(s) producing a negative electric field around a concave wall with also a coolant device(s) connected to it, which said wall will be connected to one of the chamber's ends, will also have said electron guns (or/and any other device(s) or system(s) that emits free electrons) and said gamma-ray laser's(s') be positioned to allow the electron's coiling to spin into the direction of the negative electric field to transfer the energy they got from the gamma-rays and have all the necessary parts or lack of parts' necessary parts to accomplish said task, and having an opening or being closed off, depending on the manner of the positioning of said laser(s) and/or said electron gun(s) (or/and any other device(s) that emits free electrons), at the other end of the chamber;
d) a device(s) to produce a negative electric field on a concave shaped wall on said casing;
e) a coolant device(s) (with temperature monitoring device(s) added to coolant device(s) to lower the temperature when necessity arises) connected to a concave shaped wall with a negative electric field device(s) on said casing;
f) a temperature monitoring device(s) added to said coolant device(s) or interfaced with said coolant device(s) to be also interfaced with said concave wall for purposes of monitoring temperature and preventing overheating by means of controlling said coolant device(s);
g) any necessary power source(s) for purposes of powering said parts that require powering.

2. The apparatus of claim 1, wherein said concave wall is connected to a device(s) to produce a negative electric field around said concave wall for purposes of replenishing the electrons being broken away from the bombarding high velocity electrons from said electron guns being propelled from said laser(s) towards said concave wall.

3. The apparatus of claim 1, wherein said electron gun(s) or/and any other device(s) that emits free electrons and/or said gamma-ray laser(s) be positioned in and/or connected to the casing in such a way as to allow the electron's coiling to spin into a head-on direction of the electrons of the negative electric field to transfer the energy they received from the gamma-rays of said laser(s).

4. The apparatus of claim 1, wherein there may be many of said chamber in a larger version of said casing(s) and that all said chambers be facing one singular larger version of said concave wall that is connected to said device(s) creating a negative electric field and also connected to said coolant device(s), if necessary to produce greater energy output.

5. The apparatus of claim 1, wherein there may be an opening at the end of said chamber and in said casing(s) which will be shaped to not allow any escaping electrons coming in from the opposite direction of said concave wall with the negative electric field to bounce off of any exposing part of said casing(s), so that the energy from the electrons don't get transferred in an opposite direction, if said laser(s) and/or said electron gun(s) (or/and any other device(s) that emits free electrons) are positioned in such a way to permit this thereof.

6. The apparatus of claim 1, wherein if there will be part(s) to hold said gamma-ray laser(s) into a center position(s), with then the end of said chamber may be vacuum sealed to prevent external interference(s).

7. The apparatus of claim 1, wherein said coolant device(s) is connected to said concave wall to keep the wall from overheating from exposure to high velocity electrons and/or gamma-rays.

8. The apparatus of claim 1, wherein said temperature monitoring device(s), is added and/or interfaced to said coolant device and/or possess an interface(s) with said concave wall for proper measuring of temperature for purposes of controlling temperature, and preventing overheating by means of controlling said coolant device(s).

9. The apparatus of claim 1, wherein all said parts that require power/energy are connected to and supplied by power sources thereof, and that all the necessary placements, openings, connections, and other necessities are made for said power source to the casing and said parts as well thereof.

10. The apparatus of claim 1, wherein there is a mechanism and/or method to control the output of said drive(s) and/or turn said drive(s) off or on through means of controlling said power source(s) and/or said device(s) on said drive(s).

11. The apparatus of claim 1, wherein said gamma-ray laser(s) may have a polarized filter(s) over the light emitting end of said laser(s) and will be positioned so that the peak of the light beam's wave will be facing said concave wall of the device(s) that will be producing the negative electric field if said laser(s) are positioned in such a way for such a necessity.
